(19) United States
(12) Patent Application Publication
(10) Pub. No.: US 2006/0246844 A1
(43) Pub. Date: Nov. 2, 2006

(54) Method and apparatus for depicting quality of service in mobile networks

(76) Inventors: Robert H. Kroboth, Peyton, CO (US); Juergen Voss, Wiesbaden (DE); Per Kangru, Copenhagen (DK)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 11/116,721

(22) Filed: Apr. 28, 2005

(51) Int. Cl. H04B 17/00

(52) U.S. Cl. 455/67.11

(57) ABSTRACT

A method of displaying quality of service information. The method generally comprises collecting data from a system under test; identifying quality of service parameters; calculating values for quality of service parameters based on the data collected from the system under test; graphing the values on a three dimensional graph having a first axis indicating the parameters, a second axis indicating values of the parameters, and a third axis indicating time.

### BACKGROUND OF THE INVENTION

Third-generation wireless communication systems (generally referred to as 3G systems) are currently being designed, built and placed into operation. 3G systems are typically defined by broadband packet-based transmission of data, including: text; voice; video; and multimedia, at data rates up to and possibly higher than 2 megabits per second (Mbps). One example of a 3G system is the Universal Mobile Telecommunications System (UMTS).

One example of a 3G system is the Universal Mobile Telecommunications System (UMTS). UMTS is an evolving system being developed within the International Telecommunications Union (ITU) IMT-2000 framework. UMTS was generally conceived to be a follow-on network to the group special mobile (GSM) networks that dominate Europe. UMTS employs a 5 MHz channel carrier width to deliver significantly higher data rates and increased capacity compared with second-generation networks. This 5 MHz channel carrier provides optimum use of radio resources, especially for operators who have been granted large, contiguous blocks of spectrum—typically ranging from 2×10 MHz up to 2×20 MHz—to reduce the cost of deploying 3G networks. Universally standardized via the Third Generation Partnership Project (3GPP—see www.3gpp.org) and using globally harmonized spectrum in paired and unpaired bands, 3G/UMTS in its initial phase offers theoretical bit rates of up to 384 kbps in high mobility situations, rising as high as 2 Mbps in stationary/nomadic user environments. Symmetry between uplink and downlink data rates when using paired (FDD) spectrum also means that 3G/UMTS is ideally suited for applications such as real-time video telephony.

Test and measurement systems are available for monitoring and trouble-shooting various connections and devices in emerging 3G systems. In today's highly competitive telecommunications arena, customer demands for increased network reliability and performance must be balanced against the cost of operating and maintaining the network to support the higher level of desired service. A variety of network and signal test and measurement products are available from a variety of vendors that attempt to maximize the time and resources devoted to planning, troubleshooting, installing, and maintaining modern day packet and signaling networks.

As service providers build their networks and obtain compliance with one or more of the 3G standards they desire apparatus and methods to measure and control reliability and performance of the networks. Quality of Service (“QoS”) generally refers to the capability of a network to provide a selected level of service to a selected number of customers. QoS handling is one of the underlying concepts of the system specifications drawn up by the Third Generation Partnership.

To maximize revenue, many operators offer increased levels of QoS for increased costs. Once a level of QoS has been agreed upon, it is advantageous for the network provider to be able to monitor the network with an eye to measurements of events that have an affect the QoS. Such monitoring facilitates better maintenance of the network, minimizes questions about fees charged under the agreement and allows the network operator to optimize system traffic. Accordingly providers of test and measurement systems incorporate QoS measurement methods and apparatus into their hardware and software. The resultant information is generally presented in a tabular form. Users can view different aspects, including individual measurements, by navigating through a graphical user interface.

3G networks are generally very complicated networks such that an increasing number of processes and equipment affect overall QoS. As the QoS dependencies increase, the volume of information presented to the user also increases. The present inventors have recognized a need for a graphical display that consolidates multiple sources of QoS data onto a single graphical object. Further, there is a need for enhanced display methodologies that manages many data components in a manner more accessible to a user.

### BRIEF DESCRIPTION OF THE DRAWINGS

An understanding of the present invention can be gained from the following detailed description of the invention, taken in conjunction with the accompanying drawings of which:

FIG. 1 is a block diagram of a network analysis system upon which methods in accordance with a preferred embodiment of the present invention may be practiced.

FIG. 2 is an illustration of a graphical display formulated in accordance with a preferred embodiment of the present invention.

FIG. 3 is a flow chart of a method in accordance with a preferred embodiment of the present invention.

### DETAILED DESCRIPTION

Reference will now be made in detail to the present invention, examples of which are illustrated in the accompanying drawings, wherein like reference numerals refer to like elements throughout. The detailed description which follows presents methods that may be embodied by routines and symbolic representations of operations of data bits within a computer readable medium, associated processors, general purpose personal computers and the like. These descriptions and representations are the means used by those skilled in the art to effectively convey the substance of their work to others skilled in the art.

A method is here, and generally, conceived to be a sequence of steps or actions leading to a desired result, and as such, encompasses such terms of art as “routine,” “program,” “objects,” “functions,” “subroutines,” and “procedures.” The methods recited herein may operate on a general purpose computer or other network device selectively activated or reconfigured by a routine stored in the computer and interface with the necessary signal processing capabilities. More to the point, the methods presented herein are not inherently related to any particular device; rather, various devices may be used to implement the claimed methods. Machines useful for implementation of the present invention include those manufactured by such companies as AGILENT TECHNOLOGIES, INC. and HEWLETT PACKARD, as well as other manufacturers of computer and network equipment.

With respect to the software described herein, those of ordinary skill in the art will recognize that there exist a variety of platforms and programming languages for creating software for performing the methods outlined herein. Embodiments of the present invention can be implemented using any of a number of varieties of programming languages, JAVA being one example, however, those of ordinary skill in the art also recognize that the choice of the exact platform and language is often dictated by the specifics of the actual system constructed, such that what may work for one type of system may not be efficient on another system. It should also be understood that the methods described herein are not limited to being executed as software on a microprocessor, but can also be implemented in other types of processors. For example, the methods could be implemented with HDL (Hardware Design Language) in an ASIC (application specific integrated circuits). In addition, the solution may be implemented in a single computer or could span multiple computers with each performing a subset of the tasks.

The following description will use nomenclature associated with a UMTS system, however those of ordinary skill in the art will recognize that the present invention is applicable to a wide variety of wireless systems, including any 3G system, most 2.5G systems and many 1G systems. It is anticipated that most future systems would benefit from the present invention, including the embodiments thereof described herein.

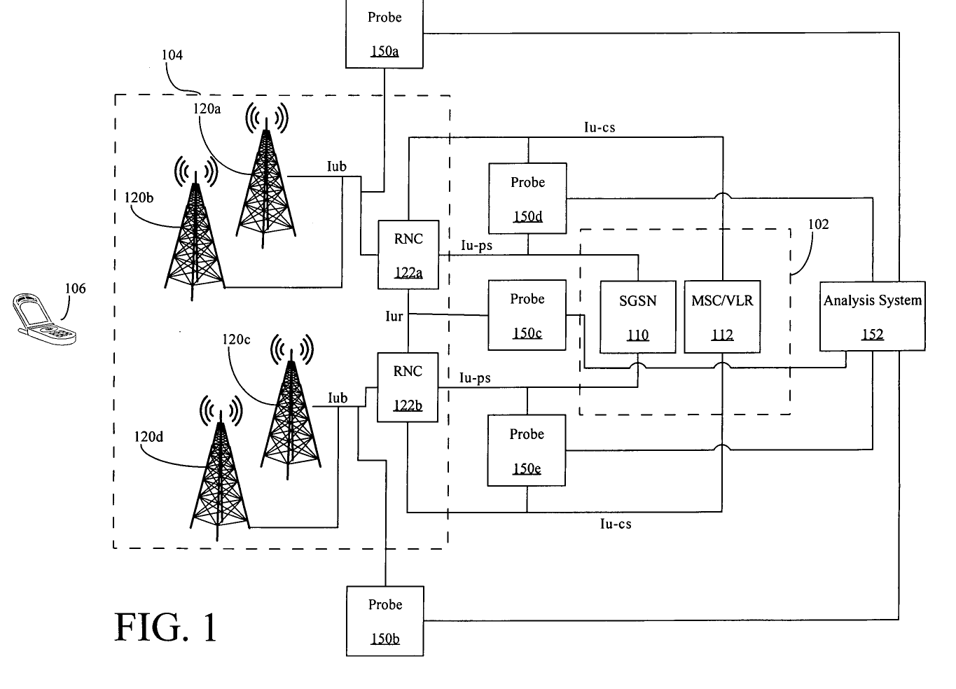

FIG. 1 is a block diagram of a network analysis system upon which methods in accordance with a preferred embodiment of the present invention may be practiced. More specifically, FIG. 1 illustrates the use of AGILENT TECHNOLOGIES' NETWORK ANALYZER family of products as applied to a UMTS network. Those of ordinary skill in the art will recognize that the methods of the present invention may be applied to test and measurement systems from other vendors and used on other networks.

FIG. 1 illustrates a distributed test and measurement system applied to a UMTS network 100. The UMTS network 100 generally comprises Core Network (CN) 102, a UMTS Terrestrial Radio Access Network (UTRAN) 104 and User Equipment (UE) 106. The main function of the CN 102 is to provide switching, routing and transit for user traffic. The CN 102 also contains hardware and software for managing databases and performing network management functions. The UTRAN 104 provides the air interface access method for UE 106. The UE 106 generally comprises a cell phone or other personal communication device. In the configuration shown in FIG. 1, the CN 102 generally comprises: one or more serving GPRS support nodes (SGSN) 110 and one or more mobile switching centers 112. The UTRAN 104 generally comprises one or more Node-B's 120n and one or more RNC's 122n.

The connections among and between the various constituent parts of a UMTS network 100 are facilitated by interfaces. For example, the air interface between the node B's 120n and the user equipment 106 is referred to as a Uu interface and generally conforms to the WCDMA air interface. Similarly, communication between node B's 120n and the RNC's 122n are facilitated by Iub interfaces. Unlike GSM, UMTS specifies an interface between RNC's 112n, termed the Iur interface. The interface between the RNC's 122n and the core network are generally termed an Iu interface. In at least the first iteration of the UMTS standard, separate Iu interfaces for circuit switched and packet switched connections are specified, termed Iu-cs and Iu-ps respectively. At least in the initial versions of UMTS, each of the wired interfaces are based on asynchronous transfer mode (ATM) technology.

Probes 150n monitor signaling protocol communications sent within the UMTS 100. The probes 150n may comprise any of a variety of network monitors such as, but not limited to, the probes in the Agilent Distributed Network Analyzers family of products. One example of a signaling protocol utilized in the UMTS 100 is the Access Link Control Application Part protocol (ALCAP). Generally, the probes 150n passively and actively monitor and gather messages passed over the various interfaces, such as the IUB, IU, and IUR link. The connections illustrated in FIG. 1 for the probes 150n are logical, it being recognized that the physical connections may follow a different topology. Thus, the probe 150a monitors the Iub interface between the RNC 222a and the node-B's 120a and 120b. The probe 150b monitors the Iub interface between the RNC 122b and the node-B's 120c and 120d. The probe 150c monitors the Iur interface between the RNC 122a and the RNC 122b. Lastly, the probes 150d and 150e monitor the Iu interfaces between the RNC's 122a and 122b, respectively, with the core network 102. An analysis system, 152 receives messages from the probes 150n, analyzes the messages, and provides information related to the signaling operation of the UMTS system 100. The analysis system may, for example, comprise an AGILENT SIGNALING ANALYZER. Analysis systems from other providers, including those integrated with probes, may also be utilized with the present invention.

The AGILENT TECHNOLOGIES' SIGNALING ANALYZER provides a distributed testing and analysis solution that maximizes the time and resources devoted to planning, troubleshooting, installing, and maintaining modern day networks. The modular design and flexibility of Signaling Analyzer solutions allows technology teams to identify potential problems and resolve faults quickly and effectively—with product configurations to exactly match engineers' differing needs. In particular, the Signaling Analyzer—Real-time (Agilent part number J7326A) enables key personnel to see network problems as they occur and turns what can be an overwhelming amount of diagnostic data into usable information. For maximum interface flexibility, the Signaling Analyzer—Real-time uses the same well-proven data acquisition module with hot-swappable Line Interfaces (Agilent part number J6801A) as Agilent's other distributed network analysis solutions. Alternatively, the Signaling Analyzer—Software Edition (Agilent Part Number J5486B) can be used off-line for post-capture analysis. Further, while a distributed system may simplify many of the problem surrounding the installation and use of a measurement system, the present invention may be practiced on non-distributed system, including those offered by such vendors as Tektronix Inc.

As noted, QoS concepts have been incorporated into 3G standards. The 3GPP has defined four QoS classes: conversational; streaming; interactive; and background. Table 1 compares the four different traffic classes in UMTS:

TABLE 1

| | Traffic class | | | |
|---|---|---|---|---|
| | Conversational | | | Background |
| | class | Streaming class | Interactive class | class |
| Fundamental | Real Time | Real Time | Best Effort | Best Effort |
| characteristics | Preserve time | Preserve time | Request | Destination is |
| | relation (variation) | relation | response pattern | not expecting |
| | between | (variation) | Preserve | the data within a |
| | information | between | payload content | certain time |
| | entities of the | information | | Preserve |
| | stream | entities of the | | payload content |
| | Conversational | stream | | |
| | pattern (stringent | | | |
| | and low delay) | | | |
| Example of the | voice | streaming video | web browsing | telemetry, |
| application | | | | emails |

The UMTS specified QoS architecture relies on bearer services characterized by QoS attributes. Bearer services are defined between various points in the system. The Radio Access Bearer (RAB) is defined between the UE and the core network. The RAB in turn relies upon two other bearer services: the Radio Bearer service between the user equipment and the UTRAN; and the Iu Bearer service between the UTRAN and the core Network. A Core Network (CN) Bearer service is defined between the UTRAN and external fixed networks, such as the Public Switched Network (PTSN). The UMTS Bearer service extends between the UE and external fixed networks, thus relying on the RAB and CN Bearer services.

Under the UMTS paradigm, to realize a certain network QoS, a Bearer Service with clearly defined characteristics and functionality must be set up from the source to the destination of a service. For example, Table 2 illustrates the UMTS Bearer Service Attributes relationship with the four traffic classes:

TABLE 2

| | Traffic Class | | | |
|---|---|---|---|---|
| | Conver- | Stream- | Inter- | Back- |
| | sational | ing | active | ground |
| Maximum Bit Rate | X | X | X | X |
| Delivery Order | X | X | X | X |
| Maximum Service Data Unit (SDU) | X | X | X | X |
| size | | | | |
| SDU Format Information | X | X | | |
| SDU Error Rate | X | X | X | X |
| Residual Bit Error Rate | X | X | X | X |
| Delivery of Erroneous SDU's | X | X | X | X |
| Transfer Delay | X | X | | |
| Guaranteed Bit Rate | X | X | | |
| Traffic Handling Priority | | | X | |
| Allocation/Retention Priority | X | X | X | X |

The Bearer Service Attributes generally represent settings that are specified during the set-up phase of an End-to-End Service. However, many are also measurable qualities. It is possible to monitor QoS compliance by monitoring compliance with the attributes of the bearer service. For example, by monitoring the size of the SDU's a determination may be made as to whether the maximum SDU size has been exceeded. By way of another example, by monitoring residual bit errors, a determination may be made as to whether the maximum residual bit error rate has been exceeded.

While the 3GPP has defined a variety of QoS related indicia, the ultimate determination of QoS must be made between the subscriber and the provider. Thus, the present invention is not limited to the QoS indicia as defined by any 3G standard, but is more broadly applicable to any QoS measurement as identified by either the subscriber or the provider. QoS may be determined on a variety of basis: per service, per user, per network segment etc. . . . Tables 3 and 4 illustrate a variety of QoS measurements for a UE-centric (Table 3) and a network-centric (Table 4) perspective that may be utilized in a accordance with the teachings of the present invention. With respect to the user centric measurements of Table 3, the measurements are further broken down based on call type: speech; video; and/or packet.

TABLE 3
Category A: Time-based Measurements (UE-Centric)

| Speech | Video | Packet |
|---|---|---|
| Call Setup Time (MO): RRC | Call Setup Time: RRC | Attach Time |
| Connection Request->Alerting | Connection Request->Alerting | |
| Call Establishment Time (MT): | Call Establishment Time: Paging | WAP Paging Loading Time |
| Paging Type 1->Alerting | Type 1->Alerting | |
| Location Area Update Time: | Video Loading Time | Streaming Loading Time |
| RRC Connection Request -> | | |
| Location Area Update Accept | | |
| IRAT Handover Time: | Video Picture Frame Rate | PDP Context Activation |
| Measurement Report (Event | | |
| 03A) -> Handover from | | |
| UTRAN Command | | |
| | H.245 Retransmission Rate | Routing Area Update Time |
| | Payload Bit Rate | |
| | Audio Packet Error Rate | |
| | Video Picture Bit Error Rate | |

TABLE 4
Category B: KPIs Ratio-based Measurements (Network-Centric)

RRC Setup Successful Rate: #RRC Connection Setup Complete/
# RRC Connection Request
RAB Establishment Success Rate: # RAB Assignment Response/
#RAB Assignment Request
Drop Call Rate: # Iu Release (Abnormal)/# RRC Connection Request
Paging Successful Rate: # Paging Response/# Paging Attempts
Location Area Update Success Rate: #Location Area Update Accept/
#Request
Activate PDP Context Success Rate: #Activate PDP Accept/
#Activate PDP Request
Attach Successful Rate: #Attach Accept/#Attach Request
IRAT Handover Successful Rate (1): # Relocation Comands/
#Relocation Required
IRAT Handover Successful Rate (2): # Handover From UTRAN
Command/# Measurement Reports
Active Set Update Successful Rate: # Active Set Update Complete/
# Active Set Updates
Cell Update Successful Rate: Total # Cell Update Confirms/Total #
Cell Updates 12/Channel Switching Successful Rate: Total # Transport
Channel Reconfig Complete/Total # Transport Channel Reconfg

In known systems, values related to QoS attributes and QoS in general have been displayed, if at all, in tabular form. As may be determined based on the above discussion, there are a variety of measurement values that relate to QoS, such that tabular displays either fail to capture enough data or are too cluttered to be of use. In one embodiment of the present invention, a three dimensional graph is generated in which time is represented by the x-axis; parameters are represented on the z-axis; and values of said parameters are represented on the y-axis. Parameters generally encompasses any QoS related measurement and aggregates thereof. It is to be noted that values may be normalized so as to maintain a usable scale.

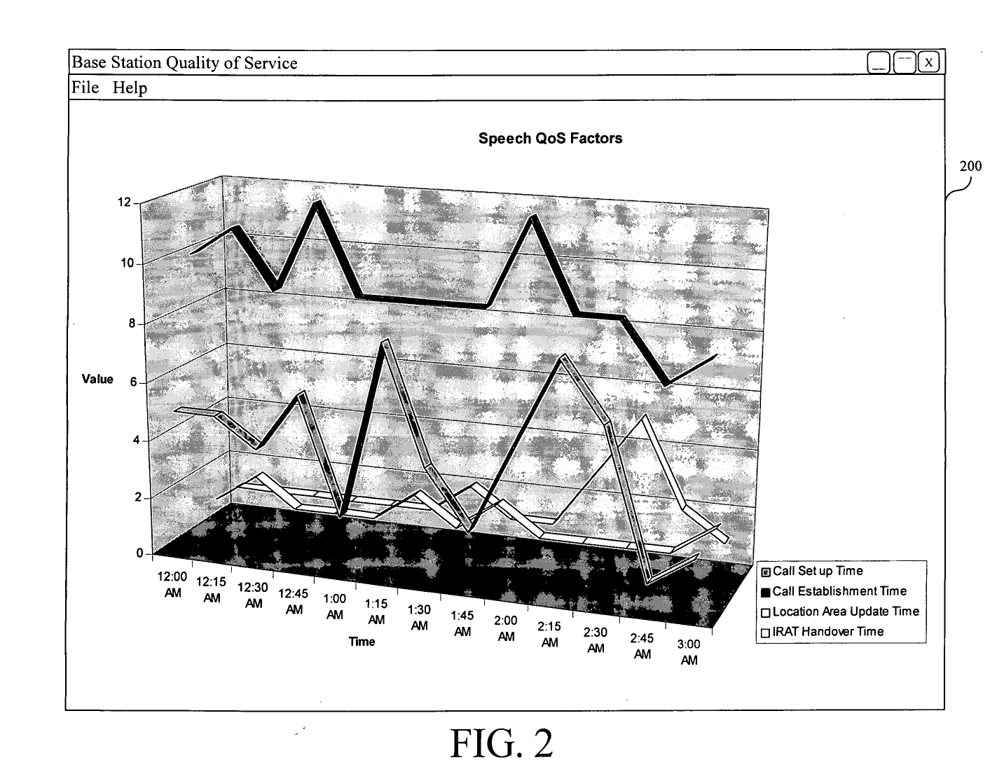

FIG. 2 is an illustration of a graphical display formulated in accordance with a preferred embodiment of the present invention. [NEED AN EXAMPLE GRAPH TO USE FOR FIG. 2]

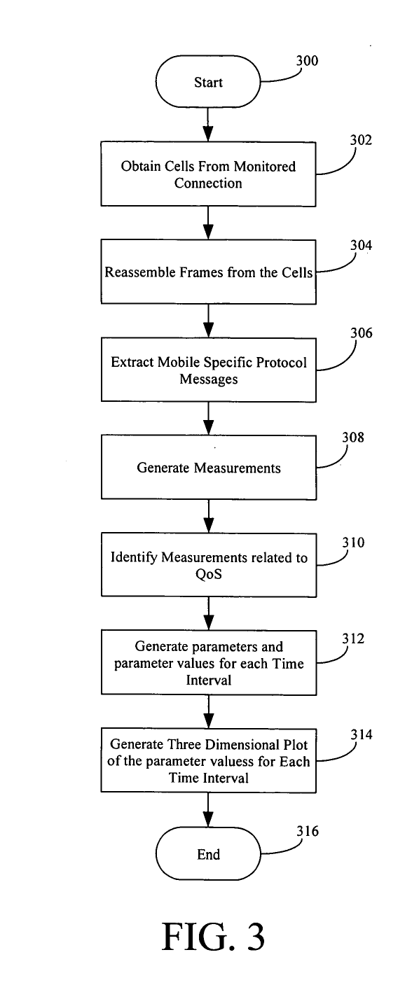

FIG. 3 is a flow chart of a method in accordance with a preferred embodiment of the present invention. The method starts in step 300. In step 302, ATM cells are obtained from a monitored connection. The cells may be obtained using a probe, such as an Agilent Distributed Network Analyzer, or other test and measurement device. In step 304, the cells are reassembled into ATM Adaptation Layer (AAL) frames. Reassemble may be performed in the probe, as is the case with the Agilent DNA where the reassembly is performed in the Line Interface Module (LIM), or in a connected device.

In ATM, the AAL adapts the different classes of applications to the ATM layer. Four types of AALs have been defined, of which two AAL2 and AAL5 are typically utilized by mobile specific protocols. AAL2 supports connection-oriented services that do not require constant bit rates. In other words, variable bit rate applications like some video schemes. AAL5 supports connection-oriented variable bit rate data services without error recovery or built in retransmission. This tradeoff provides a smaller bandwidth overhead, simpler processing requirements, and reduced implementation complexity. Reassembly of ATM cells is described in co-pending U.S. patent application Ser. No. 10/791,117, assigned to the assignee of the present application and incorporated herein by reference.

Next, in step 306, mobile specific protocol messages are extracted. Thereafter, measurements are generated based on an analysis of the extracted protocol messages. Measurements generally comprise data and context. The context may be a time stamp with an identification of the probe producing the measurement. The data may comprise raw data striped from the signal or some quantitative piece of information, e.g. a key performance indicator (KPI), about the signal. A variety of software and/or hardware products exist that analyzer signal protocol message to generate measurements. One example of suitable software is AGILENT SIGNALING ANALYZER software product.

Next, in step 310, measurements related to QoS are identified. Generally, such identification is performed by filtering using a list of measurements generated either by the user or the system designer. It may also prove useful to permit non-QoS related measurements to be utilized. In step 312, for each time interval, parameters and parameter values are generated. A parameter is description of a measurement or other value to be displayed on the graph for a given time interval. The parameter value is the associated value for each time interval. The time interval may be fixed by the system or set by the user. In many instances, a parameter simply represents an identified measurement (which may constitute a raw data value). In other instances, a parameter is an aggregation of identified measurements. Further, some parameter values may themselves be aggregated to generate another parameter and parameter value. In all cases, the raw value many be normalized to the scale of the resultant graph to arrive at a parameter value. Further, the aggregation method may be set by the system or defined by the user. Some examples of possible aggregation methods include: average, sum, lowest, highest, etc. . . . The aggregated measurements are termed parameters. In general, the term parameter value encompasses any value related to QoS that may be displayed by methods in accordance with embodiments of the present invention. Such values may or may not vary over time.

Next, in step 314, the parameters and parameter values are sent to a graphical user interface (GUI) and used to generate a three dimensional graph. By way of example, the graph may be created with time on the X-axis, the aggregated values on the Z-axis, and values on the Y-axis. In one embodiment, the graph comprises a surface graph, while in others the graph may comprise stacked bars, three-dimensional bars or other graph that displays multiple parameters over time.

Although some embodiments of the present invention has been shown and described, it will be appreciated by those skilled in the art that changes may be made in these embodiments without departing from the principles and spirit of the invention, the scope of which is defined in the claims and their equivalents. For example, while the present invention has been described with reference to an UMTS system, the teaching herein are also applicable to other 3G, 2G and 4G systems including: CDMA2000, GSM, iDEN, GPRS, and EDGE.

What is claimed is:

1. A method of displaying quality of service information, the method comprising:
collecting data from a system under test;
identifying quality of service parameters;
generating values for quality of service parameters based on the data collected from the system under test; and
graphing the values on a three dimensional graph having:
a first axis indicating the parameters;
a second axis indicating values of the parameters; and
a third axis indicating time.

2. A method, as set forth in claim 1, wherein one of the quality of service parameters comprises as aggregated quality of service parameter which is calculated based on other quality of service parameters.

3. A method, as set forth in claim 1, wherein the quality of service parameters include parameters selected from the group comprising: Call Setup Time (MO); Call Establishment Time (MT); Location Area Update Time; IRAT Handover Time; Call Setup Time: RRC Connection Request→Alerting; Call Establishment Time; Video Loading Time; Video Picture Frame Rate; H.245 Retransmission Rate; Payload Bit Rate; Audio Packet Error Rate; Video Picture Bit Error Rate; Attach Time; WAP Paging Loading Time; Streaming Loading Time; PDP Context Activation; and Routing Area Update Time.

4. A method, as set forth in claim 1, wherein the quality of service parameters include parameters selected from the group comprising: RRC Setup Successful Rate: #RRC Connection Setup Complete/# RRC Connection Request; RAB Establishment Success Rate; Drop Call Rate; Paging Successful Rate; Location Area Update Success Rate; Activate PDP Context Success Rate; IRAT Handover Successful Rate (1); IRAT Handover Successful Rate (2); Active Set Update Successful Rate; Cell Update Successful Rate; and Channel Switching Successful Rate.

5. A method of displaying quality of service in a mobile network comprising:
generating values for quality of service parameters based on the data collected from the mobile network; and
graphing the values on a three dimensional graph having:
a first axis indicating the parameters;
a second axis indicating values of the parameters; and
a third axis indicating time
